(19) United States
(12) Patent Application Publication
(10) Pub. No.: US 2007/0144590 A1
(43) Pub. Date: Jun. 28, 2007

(54) Fluid control device

(76) Inventor: Stephen T. Simmons, Carmel, IN (US)

Correspondence Address: Intellectual Property Group;Bose McKinney & Evans LLP, 2700 First Indiana Plaza, 135 North Pennsylvania Street, Indianapolis, IN, 46204, US

(21) Appl. No.: 11/316,153

(22) Filed: Dec. 22, 2005

(51) Int. Cl. G05D 16/00; G05D 16/06; E03B 1/00

(52) U.S. Cl. 137/613

(57) ABSTRACT

A fluid control device for controlling the flow of a fluid. The fluid flow device includes a modular fluid control device for controlling the flow of gas contained in a pressurized vessel. The device includes first and second manifolds and first and second isolation plates to control the flow of a pressurized gas and to maintain the pressure of the pressurized gas.

### FIELD OF THE INVENTION

The present invention relates to a fluid control device for controlling the flow of a fluid, and more particularly, a modular fluid control device for controlling the flow of gas contained in a pressurized vessel.

### BACKGROUND AND SUMMARY OF THE INVENTION

A number of fluid control devices are known which control the flow of a fluid being supplied by a vessel containing the fluid. A fluid is typically defined as either a gas or a liquid or other material which flows. For instance, a gas station includes a fluid flow device, known as a gas pump, which controls the flow of a liquid, gasoline, from a storage device or vessel to an individual's automobile. Other fluid flow control devices are commonly used to control the flow of water, for instance a fire hydrant, or for controlling the supply of natural gas, for instance into a house to provide for the heating thereof.

Other fluid control mechanisms are known which control the flow of gases, such as carbon dioxide, under pressure, which can be used in the carbonization of soft drinks or other beverages. While it is known to transport a pressurized vessel containing a gaseous carbon dioxide to a location for use, it has also been found that it is more efficient to transport liquid carbon dioxide to a location where it is then stored in a vessel or container. For instance, it has been found, that a liquid carbon dioxide storage vessel can be located within a restaurant to supply gaseous carbon dioxide for carbonating one or more soft drink dispensers within the restaurant.

Such bulk liquid carbon dioxide storage vessels are typically designed for low pressure liquid storage and to supply carbon dioxide gas where required. One known system includes a permanently installed storage vessel, a carbon dioxide fill box located on the outside of the restaurant or building, and the connecting fill and vent hoses.

Such storage vessels can include an inner vessel and an outer vessel having a space therebetween containing a vacuum and insulation. Within the inner vessel, a volume of liquid carbon dioxide is located towards the bottom of the inner vessel while a volume of gaseous carbon dioxide is located above the liquid. When gaseous carbon dioxide is needed, liquid carbon dioxide flows from the bottom of the inner vessel into a pressure building coil where the liquid changes from a liquid to a gas. When a beverage dispenser dispenses a beverage which requires carbonation, the gaseous carbon dioxide is supplied from the pressure building coil to the beverage dispenser where it is mixed with a liquid to provide a carbonated beverage.

To insure that the storage vessel can adequately supply the gaseous carbon dioxide to the beverage dispenser, a variety of plumbing components can be attached to the storage vessel. A gas delivery circuit can be coupled between the beverage dispenser and the storage vessel so that carbon dioxide gas is supplied to the beverage dispenser upon demand. A pressure building circuit can be connected to the supply vessel such that the internal operating pressure of the vessel is maintained. This pressure needs to be maintained so that the carbon dioxide gas can be supplied to the beverage dispenser and also to prevent the stored liquid carbon dioxide from changing to “dry ice”. A venting circuit may also be coupled to the storage vessel to vent gas from the storage vessel when the internal pressure of the vessel exceeds a pre-determined value, such as 300 psig. This circuit typically includes a venting tube which is coupled to the outside of the building to thereby vent the gas from the interior of the building to the exterior.

A pressure gauge can be connected through the storage vessel to the upper internal space of the vessel, where the gas is located, such that the gas pressure can be measured. The vessel can also contain a measuring device to indicate the level of the liquid carbon dioxide contained in the storage vessel.

According to an illustrative embodiment of the present disclosure there is provided a fluid control device for use with a fluid supply, including a fluid supply line to supply a fluid. The fluid control device includes an isolation plate, having a chamber with an input and an output wherein the input is adapted to operatively couple to the fluid supply line and to provide for the flow of fluid through the chamber and to the output. A stopper, disposed within the chamber, is adapted to seat within the chamber to substantially prevent the flow of fluid from the input to the output. A seal, disposed in the chamber, is spaced a distance from the stopper when the stopper is seated within the chamber.

According to another illustrative embodiment, a fluid control device for use with a fluid supply, including a fluid supply line to supply fluid is described. An isolation plate includes a chamber having an input and an output wherein the chamber is adapted to receive fluid at the input and to transfer fluid through the output. A stopper, disposed within the chamber, is adapted to seat within the chamber at a seated position to substantially prevent the flow of fluid from the input to the output. A seal, disposed in the chamber, is spaced a distance from the stopper with the stopper being located at the seated position. A manifold is coupled to the isolation plate, and includes a coupler, the coupler being coupled to the input of the chamber.

Additional features and advantages of the present invention will become apparent to those skilled in the art upon consideration of the following detailed description of illustrated embodiments exemplifying the best mode of carrying out the invention as presently perceived.

### BRIEF DESCRIPTION OF THE DRAWINGS

FIG. 1 illustrates a fluid delivery and supply system including a supply vessel.

FIG. 2 illustrates a schematic diagram of the present invention including one or more isolation plates and one or more manifolds.

FIG. 3 illustrates a perspective exploded view of the present invention including left and right isolation plates and left and right corresponding manifolds.

FIG. 4 illustrates a schematic view of the left and right manifolds coupled to the left and right isolation plates which are coupled to the storage vessel.

FIG. 5 illustrates a schematic view of a left isolation plate when a stop is substantially seated within the isolation plate to stop flow of the fluid from an input to an output.

FIG. 6 illustrates a schematic diagram of the right isolation plate when the manifold is fully seated in the isolation plate and a flow path is created from the input to the output of the isolation plate whereby the stop is not seated.

FIG. 7 illustrates a schematic view of a left isolation plate when a stop is substantially seated and the manifold is being removed therefrom.

FIG. 8 illustrates a perspective schematic view of the left isolation plate.

### DETAILED DESCRIPTION OF THE DRAWINGS

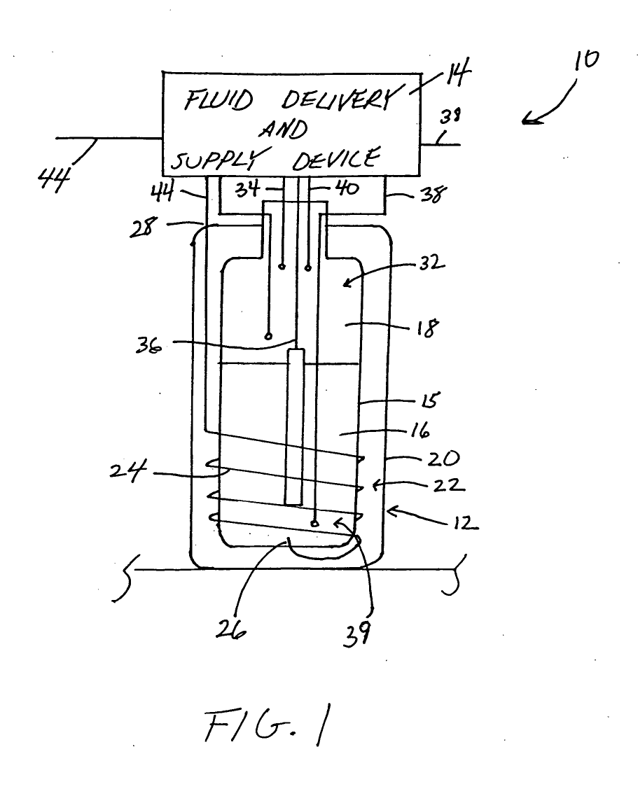

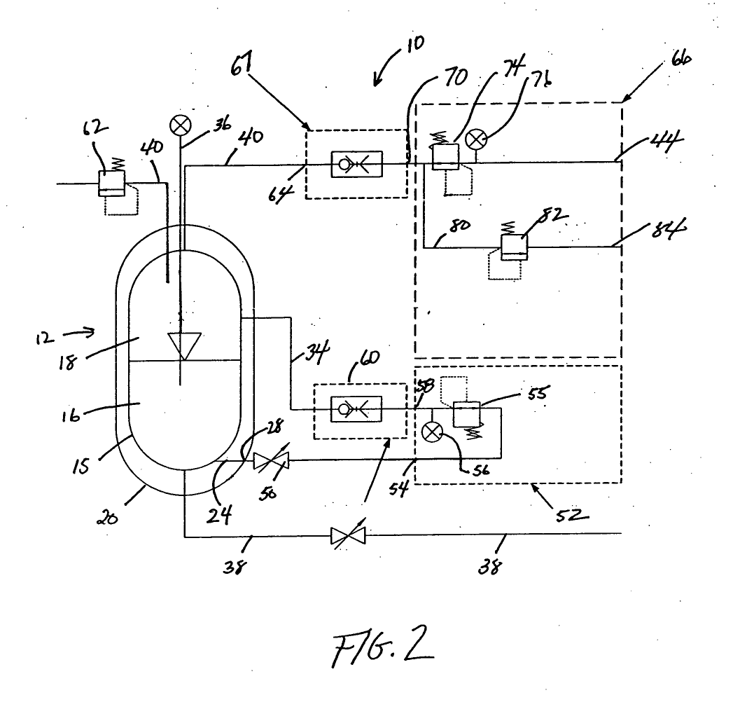

FIG. 1 illustrates a fluid delivery and supply system 10, including a supply vessel 12 coupled to a fluid delivery and supply device 14. The specifics of the fluid delivery and supply device 14 will be discussed in more detail in FIGS. 2-8. For the purposes of the present invention, the supply vessel 12 illustrated in FIG. 1 is described.

The supply vessel 12 includes an inner vessel 15 which holds liquid carbon dioxide 16 and gaseous carbon dioxide 18. The inner vessel 15 is located within an outer vessel 20 which defines a space 22 located within the outer vessel 20 and outside the inner vessel 15. Within the space 22 is a pressure building coil 24 which includes an input portion 26 which receives liquid carbon dioxide. The liquid carbon dioxide received from the input 26 travels through the coil which is coiled around the outside of the inner vessel 15 and which extends at a location 28 through the outer vessel 20. At some point along the pressure building coil 24, the liquid carbon dioxide changes to a gaseous state. Once the liquid carbon dioxide is in the gaseous state, it can be supplied as needed to a beverage dispenser.

The gaseous carbon dioxide exiting the outer vessel 20 through the coil 24 is coupled to the fluid delivery and supply device 14. In the specific embodiment of controlling and delivering a supply of carbon dioxide, the device 14 can be considered to be a carbon dioxide plumbing device. The fluid delivery and supply device 14, in part, controls the pressure of the gaseous carbon dioxide which can be returned to an upper portion 32 of the inner vessel 15 containing the gas through a line 34. A contents gauge line 36 extends from the inner vessel 15 and is coupled to the fluid delivery and supply device 14 to provide a measurement of the amount of liquid carbon dioxide contained within the inner vessel 15. A fill line 38 provides for filling of the inner vessel 15. The fill line 38 is coupled to the device 14 through which it passes, to be described later herein, and to the inner vessel 15. The fill line 38 extends to a bottom portion 39 of the inner vessel to deliver liquid carbon dioxide thereto. Lastly, a vent line 40 can extend from the inner vessel 15 and provide for the venting of gas in the case that the pressure exceeds a pre-determined limit. The vent line 40 can include one or more lines which couple the upper portion 32 to an external line or device.

The fluid delivery and supply device 14 includes a gas supply line 44 which provides the gaseous carbon dioxide to the fluid delivery and supply device 14 and then to the beverage dispensers or other devices.

Prior systems included a variety of devices such as final line regulators, pressure building regulators, relief valves, and manual ball valves, each of which needed to be individually replaced when no longer operational. In addition, when replacing these devices, the corresponding manual ball valves must be closed to prevent the venting of carbon dioxide gas into any space which might be occupied. In addition, in order to replace certain primary or secondary relief valves, all of the carbon dioxide needed be transferred to another vessel for storage while repairs take place. Also, if the ball valves were not properly manipulated during repair and/or replacement of devices, all of the carbon dioxide remaining in the tank could be vented to atmosphere. As the system vents and the pressure in the tank falls to below a certain level such as 61 psig, the remaining liquid carbon dioxide can change to dry ice. In this event, the vessel must be replaced.

FIG. 2 illustrates a schematic block diagram of the fluid delivery and supply system 10 incorporating the present invention. As previously described, a supply vessel 12 includes an inner vessel 15 containing gaseous and liquid carbon dioxide and an outer vessel 20. Liquid carbon dioxide is supplied to the inner vessel 15 through a fill line 38. To insure that the correct pressure is maintained in the inner vessel 15, a manual pressure building isolation valve 50 is coupled to the pressure building coil 24 which extends through the vessel 20 at location 28. The pressure building coil 24 is connected to a left manifold 52 at input 54. While the “manifolds”, and later “isolation plates”, are described as being “left” or “right”, these terms have been selected for ease of reference and as do not limit the embodiments described in any way. The left manifold includes a pressure building regulator 55 which is typically set to 125 psig. A pressure gauge 56 is also coupled to the left manifold and provides a reading of the pressure supplied by the line 24. An output 58 of the left manifold 52 is coupled to a left isolation plate 60 to be described in greater detail herein. The output of the left isolation plate 60 is coupled to the return line 34 of the pressure vessel 12 as previously described.

The vent line 40 of FIG. 2 passes through a relief valve 62. The output of the valve 62 vents to atmosphere. A right manifold 66 is also coupled to the vent line 40.

During operation, gaseous carbon dioxide, which can be obtained at the line 40, passes through an input 64 of a right isolation plate 67 and through an output 70. A final line regulator 74, coupled to output 70, is typically set to a value of 90 psig. A pressure gauge 76 is also provided and is coupled to the line 44 to provide a reading of the pressurized fluid being delivered. Also coupled to the output 70 through a line 80 is a secondary relief valve 82. This secondary relief valve can be set to 450 psig. This output of valve 82 is coupled to a vent line 84 for venting to atmosphere.

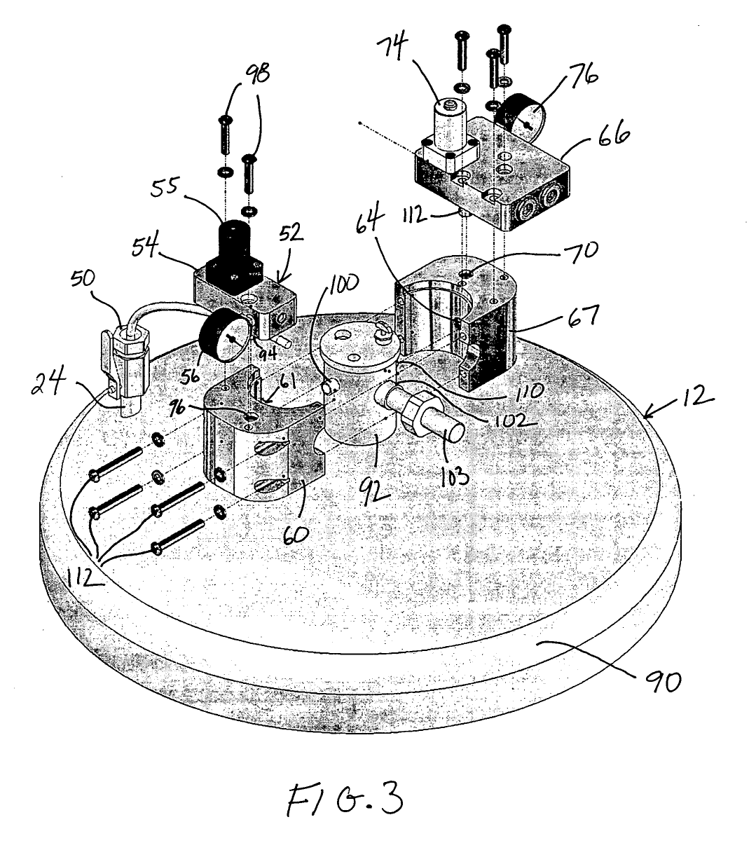

FIG. 3 illustrates a top portion 90 of the supply vessel 12 including left manifold 52, left isolation plate 60, right manifold 66, right isolation plate 67 and a neck housing 92. The top portion 90 of the supply vessel 12 includes the pressure building coil line 24 which is coupled to the manual pressure building isolation valve 50. The line 24 extends from the valve 50 and enters the input 54 of the left manifold 52. As can be seen, the pressure building regulator 55 is coupled to the manifold 52 with appropriate means. The gauge 56 extends from the manifold 52. A coupler or stem 94, coupled to the manifold 52 or made a part thereof, extends from the output of the manifold 52. To couple the left isolation plate 60 to the manifold 52, the coupler 94 is inserted into an aperture 96. As illustrated, the manifold 52 may be connected to the left isolation plate by a plurality of bolts 98 or other attaching devices to fix the manifold 52 to the isolation plate 60 in a semi-permanent fashion. The isolation plate 60 includes an aperture 61 (not shown) which is coupled to a fitting 100 located on the neck housing 92. The connection of the isolation plate at the output 61 to the fitting 100 corresponds to the return line 34 of FIG. 1. The neck housing 92 also includes an external relief aperture 102 to which an external relief valve can be coupled. A fitting 103 is shown coupled to the aperture 102. The external relief valve may include a pre-determined pressure set point, such as 300 psig, so that the pressure within the supply vessel 12 may be relieved if necessary.

In addition to the fitting 100 located on the neck housing 92, a fitting 110 extends from an opposite side of the neck housing. When the isolation plates 60 and 67 are coupled together with fasteners 112, the fitting 110 extends into the input 64 of the right isolation plate 67. To complete the assembly of the fluid delivery and supply device 14, a coupler or stem 112, coupled to the manifold 66 or made a part thereof, is inserted into the output 70 of the right isolation plate 67. It is within the scope of the present invention to couple each manifold separately to the vessel 12.

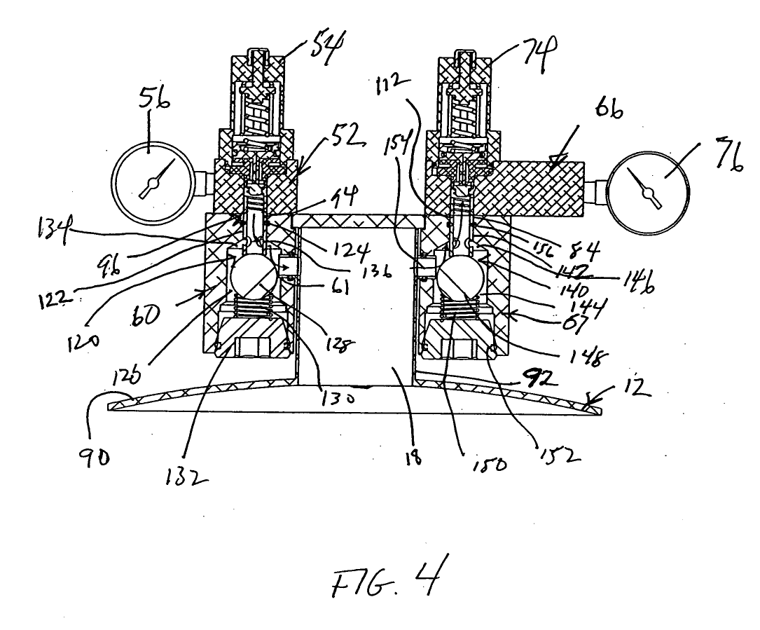

FIG. 4 illustrates a partial schematic view of the top portion 90 of the supply vessel 12, including the neck 92, to which the left manifold 52 and left isolation plate 60 as well as the right manifold 66 and right isolation plate 67 are coupled. In this particular view, the regulator 54 and regulator 74 are shown disposed directly over the top of the respective inputs for the isolation plates. In actuality, both the regulator 54 and the regulator 74 are offset from the input of the respective isolation plates, as previously illustrated in FIG. 3.

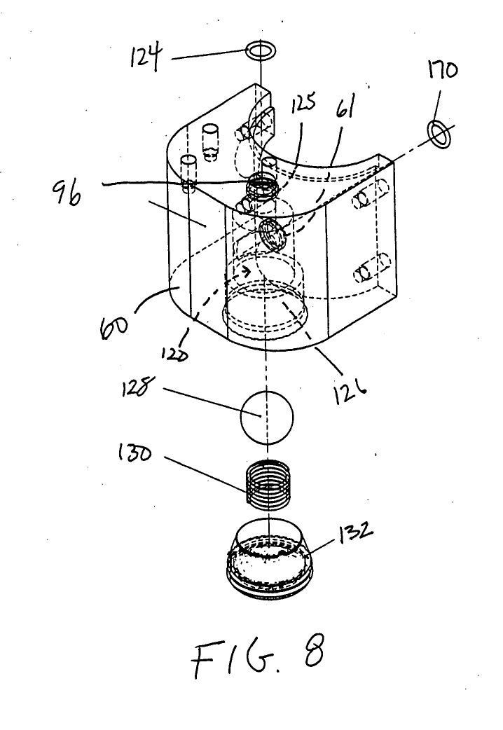

As previously described for the left manifold 52, a coupler or stem 94, extends from the manifold and fits within the input 96 of the left isolation plate 60. The left isolation plate 60 includes a chamber 120 coupled to the input 96 and the output 61. When the manifold 52 is coupled to the isolation plate 60, the stem 94 is inserted into a first portion 122 of the chamber 120. The first portion 122 of the chamber 120 includes a dimension which is slightly larger than the outer dimension of the stem 94. Within the first portion of the chamber 122, a seal 124, such as an o-ring seal, is located within a groove 125 (see FIG. 8) formed therein. When the stem 94 is inserted, the stem 94 passes by the seal 124, thereby creating a substantially fluid tight seal between the outer walls of the stem 94 and the inner walls of the first portion 122 of the chamber. A second portion 126 of the chamber has an inner dimension which is larger than the first portion 122 of the chamber to accept a stopper 128 disposed therein. In this particular embodiment, the stopper 128 comprises a sphere which is held within the portion 126 by a spring 130 held in place by a plug 132. The spring 130 biases the sphere 128 against a chamfer 134 defined at the intersection of the first portion 122 and the second portion 126. The chamfer includes a slope selected to cooperate with the outer surface of the sphere 128 such that when the manifold 52 is removed from the left isolation plate 60, the sphere 128 contacts the chamfer 134 to substantially prevent any fluid from passing from the first portion 122 to the second portion 126 and through the output 61. It is within the scope of the present invention to include other types and shapes of stoppers.

When the manifold 52, is however sufficiently inserted into the first portion 122, the stem 94 forces the sphere 128 against the spring 130 which is held in place and compressed. As can be seen, the stem 94 includes one or more apertures 136 which provide for fluid flow through the manifold and out through the isolation plate.

The right isolation plate 67 includes similar features described for the left isolation plate 60. For instance, the right isolation plate 67 includes a chamber 140 having a first portion 142, a second portion 144, and a chamfer 146 located at the intersection of the first portion 142 and the second portion 144. A stopper or sphere 148 is located within the second portion 144 and is biased by a spring 150 held in place by a plug 152. While the fluid flow through the right isolation plate 67 and right manifold 66 is in a direction 154 opposite that of the fluid flow of the left isolation plate 60 and right manifold 52, the operation of the manifolds are substantially the same. A manifold can accommodate fluid flow in either direction depending on the application. When the manifold 66 is coupled to the left isolation plate 67, the stem 112 is inserted into the first portion 142 past an o-ring seal 156. When fully inserted, the stem 112 forces the sphere 148 in a downward direction, as illustrated, thereby compressing the spring 150 to open the fluid flow path at path 154. To enable the flow of fluid, the stem includes apertures 155.

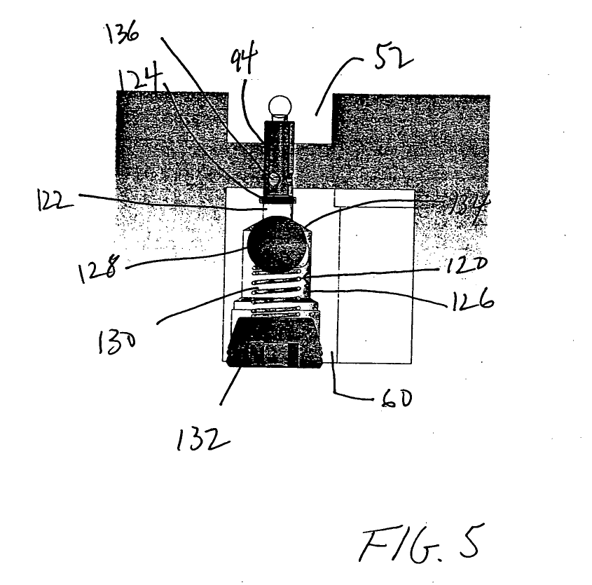

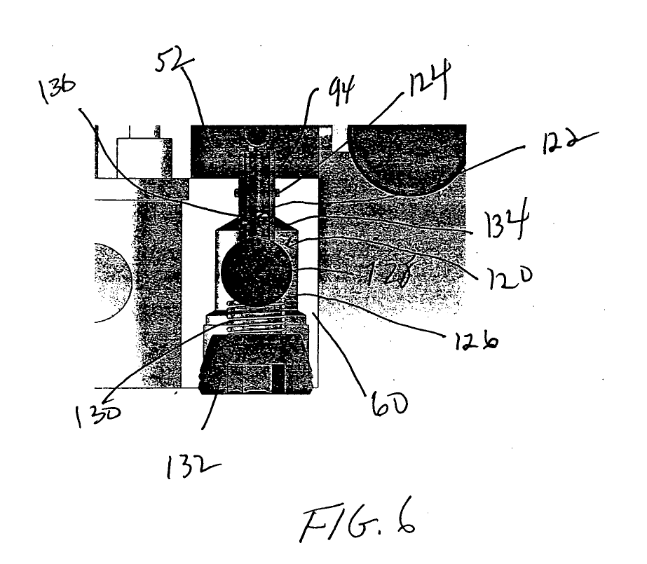

FIGS. 5-7 illustrate the sequence of the insertion and removal of the manifold 52 from the left isolation plate 60. Insertion of the left manifold 52 begins with placing the stem 94 into the first portion 122 of the chamber. As the bottom of the stem 94 moves past the seal 124, the bottom of the stem 94 contacts the sphere, which moves towards the plug 132. As the sphere 128 moves away from the chamfer 134, the seal is broken between the stopper 128 and the chamfer 134. As illustrated in FIG. 6, once the manifold 52 is fully seated against the left isolation plate 60, the aperture 136 is located completely within the second portion 126 such that fluid flow can occur. In this position, the flow of fluid through the manifold and through the isolation plate 60 is enabled.

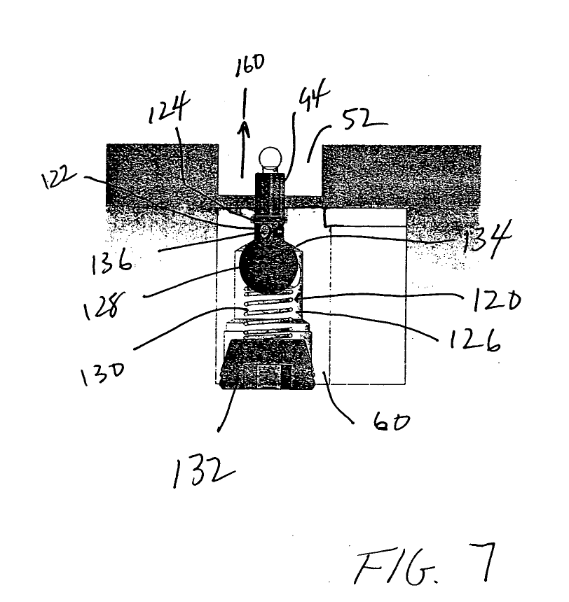

On occasion, the manifold 52 must be removed from the isolation plate 60 as is illustrated in FIG. 7. When the manifold 52 is moved in a direction 160, the stem 94 is removed from the first portion 122. When the sphere first becomes seated against the chamfer 134, the aperture 136 is located between the top of the sphere 128 and the seal 124. It has been found that by locating the aperture 136 at a selected point along the stem 94, only a very small amount of fluid can be released when the manifold 52 is removed from the isolation plate 60. The amount of fluid released is that which is contained within the stem and the manifold. It is desirable, therefore, to select the size of the aperture 136 such that the entire aperture is located between the seal 124 and the top of the sphere 128 when the sphere 128 first becomes seated. It is within the scope of the present invention to have apertures of different sizes so long as the aperture 136 is located as previously described.

FIG. 8 illustrates a perspective schematic view of the left isolation plate 60. The sphere 128 is positioned within the second portion 126 of the chamber 120 and is held in place by the spring 130 and the plug 132 as previously described. As illustrated, the chamber 120 is coupled to the input 96 which receives the stem 94. The chamber 120 is also coupled to the aperture 61 which is coupled to the fitting 100. A seal is formed between the aperture 61 and the fitting 100 with an o-ring 170 which is disposed within a channel formed within the interior sidewall of the channel connecting the chamber 120 to the aperture 61. While this description is for the left isolation plate 60, the right isolation plate is substantially the same.

The isolation plate can be made by a variety of methods including machining or forming from a mold. A variety of materials including aluminum, brass, and plastics, can be used. In addition, the isolation plate need not be made in the shape as illustrated but may include other geometric shapes such as cubes, rectangular prisms, spheres or half spheres which can selected to couple to the system.

Although the invention has been described in detail with reference to certain preferred embodiments, variations and modifications exist within the spirit and scope of the invention as described and defined in the following claims.

What is claimed is:

1. A fluid control device for use with a fluid supply, including a fluid supply line to supply a fluid, comprising:
an isolation plate, including a chamber having an input and an output, the input adapted to operatively couple to the fluid supply line and to provide for the flow of fluid through the chamber and to the output;
a stopper, disposed within the chamber, adapted to seat within the chamber to substantially prevent the flow of fluid from the input to the output; and
a seal, disposed in the chamber, spaced a distance from the stopper when the stopper is seated within the chamber.

2. The control device of claim 1, wherein the chamber includes a first portion, coupled to the input, and a second portion, coupled to the output, wherein an interior wall of the second portion, at the intersection of the first portion and the second portion defines a chamfer.

3. The control device of claim 2, wherein the stopper includes a dimension adapted to sealingly fit the chamfer to thereby substantially prevent the flow of fluid from the input to the output.

4. The control device of claim 3, wherein the stopper comprises a sphere.

5. The control device of claim 4, wherein the sphere comprises a material.

6. The control device of claim 1, further comprising a manifold, the manifold including a coupler to couple the manifold to the input of the isolation plate.

7. The control device of claim 6, wherein the first portion of the isolation plate comprises a channel having a first dimension, wherein the seal is disposed within the channel.

8. The control device of claim 7, wherein the coupler comprises a stem, having a second dimension less than the first dimension, whereby the stem fits within the channel.

9. The control device of claim 8, wherein the stem includes a distal portion, spaced from the manifold, wherein the distal portion contacts the stopper when sufficiently inserted into the first portion.

10. The control device of claim 9, wherein the stem includes an aperture disposed between the distal portion and the manifold.

11. The control device of claim 10, wherein the aperture is disposed between the seal and the stopper with the stem located in the first portion.

12. The control device of claim 11, wherein the seal seals to the stem when the stopper seats to substantially prevent the flow of fluid from the input to the output.

13. The control device of claim 12, wherein the aperture is located between the seal and the stopper when the stopper is located in the seated position to substantially prevent flow of fluid from the input to the output.

14. The control device of claim 6, wherein the manifold comprises a manifold channel having an manifold input and a manifold output, the manifold input adapted to couple to the fluid supply line and the manifold output coupled to the stem.

15. The control device of claim 14, further comprising a regulator coupled to the channel, the regulator including a pressure sensing device, adapted to control the flow of fluid through the regulator.

16. The control device of claim 15, further comprising a relief valve, coupled to the channel, the relief valve including a mechanism to open the channel when the fluid pressure within the channel exceeds a predetermined value.

17. A fluid control device for use with a fluid supply, including a fluid supply line to supply fluid, comprising:
an isolation plate, including a chamber having an input and an output, the chamber adapted to receive fluid at the input and to transfer fluid through the output;
a stopper, disposed within the chamber, adapted to seat within the chamber at a seated position to substantially prevent the flow of fluid from the input to the output;
a seal, disposed in the chamber, spaced a distance from the stopper with the stopper being located at the seated position; and
a manifold, coupled to the isolation plate, including a coupler, the coupler coupled to the input of the chamber.

18. The control device of claim 17, wherein a portion of the coupler is located within the chamber.

19. The control device of claim 18, wherein the portion of the coupler located within the chamber includes an aperture.

20. The control device of claim 19, wherein the aperture is located between the seal and the stopper with the stopper being located at the seated position.
